(19) United States
(12) Patent Application Publication
(10) Pub. No.: US 2024/0423765 A1
(43) Pub. Date: Dec. 26, 2024

(54) EXPOSURE DEVICE FOR ILLUMINATING A DENTAL OBJECT

(71) Applicant: Ivoclar Vivadent AG, Schaan (LI)

(72) Inventors: Christian NIEDRIG, Azmoos (CH); Markus RAMPF, Seewis (CH); Marc DITTMER, Feldkirch (AT); Christian RITZBERGER, Grabs (CH)

(21) Appl. No.: 18/753,009

(22) Filed: Jun. 25, 2024

(30) Foreign Application Priority Data
Jun. 26, 2023 (EP) 23181428.6

(51) Int. Cl. A61C 13/08; G21K 5/08

(52) U.S. Cl. CPC A61C 13/082; G21K 5/08

(57) ABSTRACT

An exposure device (100) for illuminating a dental object (101), having a chamber (103) for receiving the dental object (101); and a radiation source (105) for exposing the dental object (101) to a wavelength greater than 350 nm and to a power density greater than 10 W/cm².

### CROSS-REFERENCE TO RELATED APPLICATIONS

This application claims priority to European Patent Application No. 23181428.6 filed on Jun. 26, 2023, the disclosure of which is incorporated herein by reference in its entirety.

### TECHNICAL FIELD

The present invention relates to an exposure device for illuminating a dental object and a method of illuminating a dental object.

### BACKGROUND

Polychromatic glasses and glass-ceramics can be colored by exposure together with a thermal treatment, such as a quartz glass, a quartz glass-ceramic, a lithium aluminosilicate glass, a lithium aluminosilicate glass-ceramic, a lithium silicate glass or a lithium silicate glass-ceramic. Exposure is usually by means of UV radiation. After exposure, the different color effects are mainly produced by means of temperature treatment.

However, exposure to UV radiation has a low penetration depth into the glass ceramic. UV lasers, UV LEDs and UV optics are technically complex and have large dimensions.

US20220287800, 20230121316, and 6386865 are directed to devices used in the fabrication of dental objects and are hereby incorporated by reference.

### SUMMARY

It is the technical task of the present invention to carry out the coloring of a dental object efficiently and with less technical effort.

This task is solved by subject matter according to the independent claims. Technically advantageous embodiments are the subject matter of the dependent claims, the description and the drawings.

According to a first aspect, the technical task is solved by an exposure device for illuminating a dental object, comprising a chamber for receiving the dental object; and a radiation source for exposing the dental object to a wavelength greater than 350 nm and to a power density greater than 10 W/cm². The dental object can be exposed at a designated position inside the chamber to radiation with a wavelength greater than 350 nm and a power density greater than 10 W/cm². The power density can also exceed 100 W/cm² or 1 kW/cm². These power densities can be used to excite multiphoton processes within the dental object.

The exposure device achieves the technical advantage that a greater penetration depth of the radiation into the material is achieved when coloring the dental object. This means that the entire volume of the dental object is exposable and activatable. If a wavelength greater than 350 nm is used, more efficient devices and optics can be used, and shorter exposure times can be realized.

In a technically advantageous embodiment of the exposure device, the radiation source is configured to expose the dental object to a wavelength that is greater than 700 nm.

This provides the technical advantage, for example, that even greater penetration depths are achieved.

In a further technically advantageous embodiment of the exposure device, the radiation source is configured to emit radiation with a power of greater than 1 W. For example, a laser could scan the surface with 10,000 exposure points. With an exposure time of 0.1 seconds per exposure point, the total exposure time is 1000 seconds. In this case, a laser output power of 1 W would be sufficient. This provides the technical advantage, for example, that the dental object can be illuminated efficiently.

In a further technically advantageous embodiment of the exposure device, the radiation source is formed by a laser, a light-emitting diode or a mercury vapor lamp. This provides the technical advantage, for example, that the radiation for illuminating the dental object can be generated efficiently.

In a further technically advantageous embodiment of the exposure device, the laser is a Ti-sapphire laser or an Nd-YAG laser. This provides the technical advantage, for example, that the power density can be generated easily and can be irradiated onto the dental object without losses.

In a further technically advantageous embodiment of the exposure device, the radiation source is configured to emit radiation in a wavelength range between 350 nm and 1800 nm, preferably between 350 nm and 1500 nm and particularly preferably between 350 nm and 1100 nm. This provides the technical advantage, for example, that the coloring of the dental object can be carried out efficiently.

In a further technically advantageous embodiment of the exposure device, the exposure device comprises an intensity adjustment device for adjusting a radiation intensity of the radiation source. This provides the technical advantage, for example, that an intensity of the exposure can be set depending on a material used.

In a further technically advantageous embodiment of the exposure device, a maximum and/or average radiation intensity of the radiation source is 100 W or 300 W. In the case of a laser, the average radiation intensity can be averaged over a plurality of laser pulses. In the case of a light-emitting diode or mercury vapor lamp, the average radiation intensity can be determined continuously over time. This provides the technical advantage, for example, of preventing excessive exposure of the dental object.

In a further technically advantageous embodiment of the exposure device, the exposure device comprises a timer device for activating the radiation source for a predetermined period of time. This provides the technical advantage, for example, that a predetermined energy per area can be irradiated onto the dental object.

According to a second aspect, the technical task is solved by a method of illuminating a dental object, comprising the step of exposing the dental object to a wavelength greater than 350 nm and to a power density greater than 10 W/cm². The method achieves the same technical advantages as the exposure device according to the first aspect.

In a technically advantageous embodiment of the method, the wavelength is greater than 500 or 700 nm. This also provides the technical advantage, for example, that even greater penetration depths can be achieved.

In a further technically advantageous embodiment of the method, the power of the radiation is more than 1 W. This also provides the technical advantage, for example, that the dental object can be illuminated efficiently.

In a further technically advantageous embodiment of the method, the radiation is emitted in a wavelength range between 350 nm and 1800 nm, preferably between 350 nm and 1500 nm and particularly preferably between 350 nm and 1100 nm. Coloring can also be achieved by thermal treatment. This provides the technical advantage, for example, that the coloring or exposure of the dental object can be carried out efficiently.

In a further technically advantageous embodiment of the method, the dental object is exposed for a predetermined period of time. This provides the technical advantage, for example, that a predetermined energy per area can be irradiated onto the dental object.

According to a third aspect, the technical task is solved by an exposure system comprising an exposure device according to the first aspect and a dental object comprising a polychromatic glass and or a polychromatic glass-ceramic. The exposure system achieves the same technical advantages as the exposure device according to the first aspect.

### BRIEF DESCRIPTION OF THE DRAWINGS

Exemplary embodiments of the invention are shown in the drawings and are described in more detail below, in which:

FIG. 1 shows a schematic view of an exposure device; and

FIG. 2 shows a block diagram of a method of illuminating the dental object.

### DETAILED DESCRIPTION

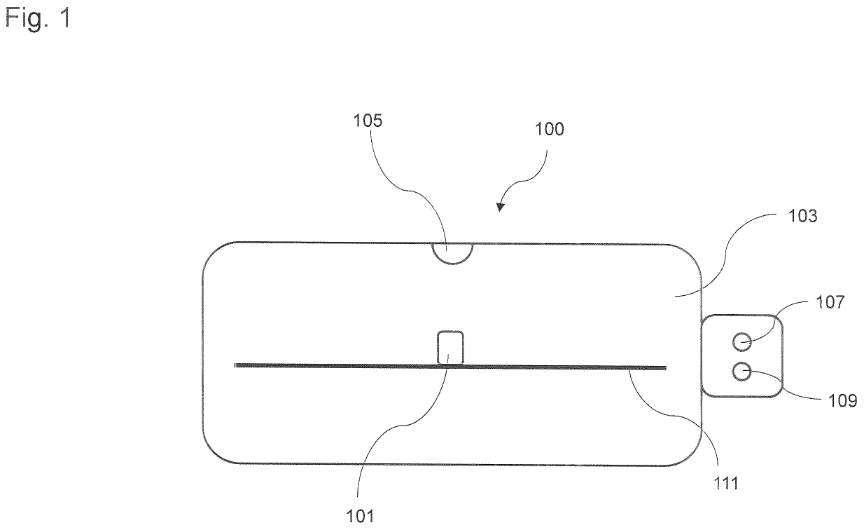

FIG. 1 shows a schematic view of an exposure device 100. The exposure device 100 is used to expose and activate a dental object 101 which is made of a polychromatic glass and/or a polychromatic glass-ceramic. The dental object 101 is a dental 35 restoration, such as a crown, a bridge, a veneer, an abutment, an inlay or an onlay.

For this purpose, the polychromatic glasses and glass-ceramics comprise, for example, an oxidizable component and a reducible coloring component. The oxidizable component is a component which can be oxidized or stimulated to emit electrons by irradiation. Oxidizable components are, for example, cerium ions, europium ions, erbium ions, copper ions and mixtures thereof. The reducible coloring component is, for example, a component which can be reduced to form a color change. Preferred reducible coloring components are cations of metals, such as silver, gold, copper or combinations thereof.

The exposure device 100 comprises a chamber 103 into which the dental object 101 is placed in order to subject it to illumination. The exposure device 100 comprises a designated position 111 for the dental object 101 to be exposed, such as a support surface or a holder for the dental object 101. The chamber 103 may be configured with reflective walls in order to increase the intensity of the radiation at the location of the dental object 101. The radiation source 105 is arranged, for example, in a ceiling wall of the chamber 103. In general, however, the radiation source 105 can also be arranged at other positions as long as the dental object is illuminated with the intended power density.

A radiation source 105 is used to expose the dental object 101 at the designated position 111 to a wavelength which is greater than 350 nm and to a power density at the designated position 111 which is greater than 10 W/cm². Suitable radiation sources 105 in this context are, for example, an Nd-YAG laser or Ti-sapphire laser. When using a laser, the radiation can be directed directly and in a targeted manner onto the dental object 101.

The radiation source 105 may also be formed by a suitable light emitting diode or a mercury vapor lamp. In general, any radiation source 105 capable of emitting radiation with a wavelength greater than 350 nm and with a power density greater than 10 W/cm² may be used.

The exposure device 100 comprises an intensity adjustment device 107 for adjusting a radiation intensity of the radiation source 105. This allows the intensity of the radiation to be increased or decreased. The intensity adjustment device 107 comprises, for example, an electric control system with which the radiation intensity of the radiation source 105 can be changed. To this end, a manual regulator may be provided by means of which the user can adjust the radiation intensity of the radiation source 105. The regulator may be formed by a mechanical interface or an electronic interface.

Furthermore, the exposure device 100 comprises a timer device 109 for activating the radiation source 105 for a predetermined period of time. The timer device 109 is, for example, an electric control system that switches on the radiation source for a predetermined period of time, such as 60 seconds. To this end, a manual regulator may also be provided by means of which the user can set the time period. The regulator can be formed by a mechanical interface or an electronic interface.

The exposure device 100 may comprise an electronic controller with which the radiation source 105 and other functions of the exposure device 100 can be controlled. The controller may comprise a microprocessor by means of which various control programs may be executed. In addition, the exposure device 100 may comprise a heating device for heating the dental object 101 or a molding device for molding the dental object 101.

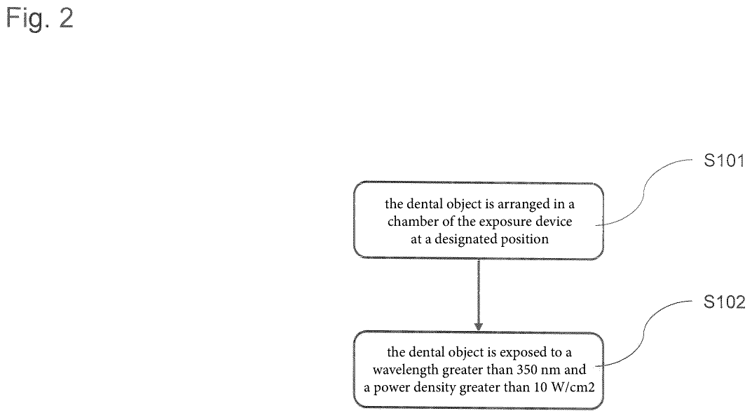

FIG. 2 shows a block diagram of a method of illuminating the dental object 101. In step S101, the dental object 101 is arranged in a chamber 103 of the exposure device 100 at a designated position. In step S102, the dental object 101 is exposed to a wavelength greater than 350 nm and a power density greater than 10 W/cm². This activates the dental object so that coloring can take place, for example during a temperature treatment. In addition, the method may comprise the step of manufacturing or molding the dental object or the step of thermally treating the dental object.

By using radiation with a wavelength greater than 350 nm, it is possible to expose at a greater penetration depth in the volume of the material of the dental object 101. In addition, the effective exposure time is considerably shorter. Exposure and activation of the glasses and glass-ceramics to achieve coloration in the entire volume after thermal treatment can be carried out more efficiently with this radiation. Exposure or activation can be carried out in the entire material volume of the dental object 101.

When using radiation with a wavelength greater than 350 nm, smaller and simpler devices and optics can be used and shorter exposure times for coloring can be achieved. The exposure device 100 can be used together with a manufacturing process (CAM—Computer Aided Manufacturing). In this case, exposure or activation can be carried out during the ablative shaping of the dental object. The exposure device 100 may be used together with a thermal process, for example in a furnace. In this case, exposure or activation can be performed during thermal tempering, crystallization or sintering.

All the features explained and shown in connection with individual embodiments of the invention can be provided in different combinations in the subject matter according to the invention in order to realize their advantageous effects at the same time.

All method steps can be implemented by devices that are suitable for executing the respective method step. All functions performed by features of the subject matter can be a method step of a method.

The scope of protection of the present invention is given by the claims and is not limited by the features explained in the description or shown in the figures.

### REFERENCE LIST

100 Exposure device
101 Dental object
103 Chamber
105 Radiation source
107 Intensity adjustment device
109 Timer device
111 Position

1. An exposure device for illuminating a dental object, comprising:
a chamber for receiving the dental object; and
a radiation source for exposing the dental object to a wavelength greater than 350 nm and to a power density greater than 10 w/cm².

2. The exposure device according to claim 1,
wherein the radiation source is configured to expose the dental object to a wavelength which is greater than 500 nm or 700 nm.

3. The exposure device according to claim 1,
wherein the radiation source is configured to emit radiation with a power of greater than 1 W.

4. The exposure device according to claim 1,
wherein the radiation source is formed by a laser, a light emitting diode or a mercury vapor lamp.

5. The exposure device according to claim 4,
wherein the laser is a Ti-sapphire laser or an Nd-YAG laser.

6. The exposure device according to claim 1,
wherein the radiation source is configured to emit radiation in a wavelength range between 350 nm and 1800 nm.

7. The exposure device according to claim 1,
wherein the radiation source is configured to emit radiation in a wavelength range between 350 nm and 1500 nm.

8. The exposure device according to claim 1,
wherein the radiation source is configured to emit radiation in a wavelength range between 350 and 1100 nm.

9. The exposure device according to claim 1,
wherein the exposure device comprises an intensity adjuster device for adjusting a radiation intensity of the radiation source.

10. The exposure device according to claim 1,
wherein a maximum and/or average radiation intensity of the radiation source is 100 W or 300 W.

11. The exposure device according to claim 1,
wherein the exposure device comprises a timer for activating the radiation source for a predetermined period of time.

12. A method of illuminating a dental object, comprising:
exposing the dental object to a wavelength greater than 350 nm and to a power density greater than 10 W/cm².

13. The method according to claim 12,
wherein the wavelength is greater than 700 nm.

14. The method according to claim 12,
wherein the power of the radiation is more than 1 W.

15. The method according to claim 12,
wherein the radiation is emitted in a wavelength range between 350 nm and 1800 nm.

16. The method according to claim 12,
wherein the radiation is emitted in a wavelength range between 350 nm and 1500 nm.

17. The method according to claim 12,
wherein the radiation is emitted in a wavelength range between 350 nm and 1100 nm.

18. The method according to claim 12,
wherein the dental object is exposed for a predetermined period of time.

19. An exposure system comprising
an exposure device according to claim 1 and
a dental object comprising a polychromatic glass and or a polychromatic glass-ceramic.
